(19) United States
(12) Patent Application Publication
(10) Pub. No.: US 2011/0042834 A1
(43) Pub. Date: Feb. 24, 2011

(54) WATER CARBONATOR WITH PLASTIC END PLATES

(75) Inventor: Carlo Maria Pensa, Esino Lario (IT)

Correspondence Address: DILWORTH & BARRESE, LLP, 1000 WOODBURY ROAD, SUITE 405, WOODBURY, NY, 11797, US

(73) Assignee: O.D.L. SRL, Lierna (IT)

(21) Appl. No.: 12/922,972

(22) PCT Filed: Mar. 9, 2009
(86) PCT No.: PCT/EP2009/001763

§ 371 Date: Sep. 16, 2010

(30) Foreign Application Priority Data
Mar. 17, 2008 (IT) MI/2008/A/000441

(51) Int. Cl. B01F 3/04

(52) U.S. Cl. 261/50.3

(57) ABSTRACT

A water carbonator comprising a tubular body (1) closed at the ends by a pair of end plates (2, 4) preset for the hydraulic circuit for mixing water with CO₂, said end plates (2, 4) being secured to said tubular body (1) by a shape coupling and assuring for the sealing at the pressure of the fluid contained by interposing elastic gaskets.

The present invention relates to a water carbonator comprising a tubular container shaped such that it holds the plastic end plates without using any additional mechanical fastenings.

The water carbonators are well known apparatuses that serve to add carbon dioxide ratios to the water contained therein in order to thus obtain sparkling water, also commonly known as soda. They are substantially constituted by a container in which suitable passageways are formed such that there will be a CO₂ inlet, a water inlet, a sparkling water outlet and suitable instruments for checking water level. A relief valve, due to the characteristics of pressurized tank with gas presence, is provided as well. The operation typically occurs by filling the container up with CO₂ having a pressure ranging between 3 and 7 bars, then by letting the water entering, pushed by a higher pressure pump, through an orifice such that it is nebulized in the form of micro drops that offer a wide exchange surface and therefore gas absorption, the water having, due to Bernoulli effect, high speed. Suitable construction expedients, such as rebounding plates or tubes with holes at the nozzle level and particular profile at the end, are often inserted to raise to the most the water gassing.

The water level within the carbonator is kept such that in the upper portion there is always a CO₂ amount. In order to obtain that result different systems are used: the most used system provide feelers that allow for detecting the presence of water between the feeler tip and the wall or other element connectable to an electronic system. They can be formed with one or two feelers. In the embodiment with two feelers, as the drawn water causes the level to fall below the longest feeler, the electronic system, which detects the dielectric between feeler and wall, actuates the pump operating till the level reaches the shortest feeler; in the embodiment provided with only one feeler, typical for carbonators having small capacity, some delays in the pump starting and stopping are added such that there is no instability due to the wave therein generated.

In the more common configuration the carbonators are formed with stainless steel having the pipe fittings, even formed with stainless steel, welded: from a technical standpoint this is the best solution but it has high manufacturing cost and the pipe fitting size is noticeable.

Alternative solutions were therefore studied having plastic parts which allow for forming the inlet and outlet passageways more easily and in a cost-effective manner.

The currently adopted solutions provide for making the container with a steel tube and a pair of head, also called end plates, of plastic material and held by tie rods that can be inside or outside the tube. The cheapest solution has just one central tie rod which holds both plates, but it is a solution having crack failure risk: two tie rods would assure of more reliability but would increase cost.

The solution provided for the carbonator according to the present invention fully overcomes the problem in a particularly cheap manner and provides that the same outer envelope holds the two end plates.

A detailed description of some preferred embodiments according to the invention will be now provided with reference to the annexed drawings, in which:

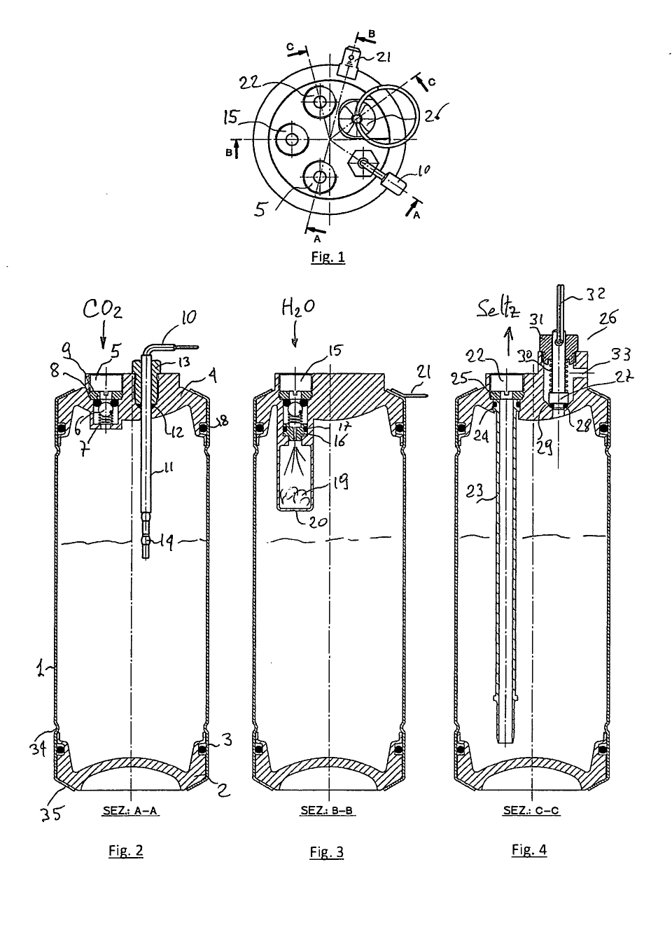

FIG. 1 is a top view of a first preferred embodiment according to the present invention,

FIG. 2 is a first cross-sectional view taken along line A—A in FIG. 1,

FIG. 3 is a second cross-sectional view taken along line B—B in FIG. 1,

FIG. 4 is a third cross-sectional view taken along line C—C in FIG. 1,

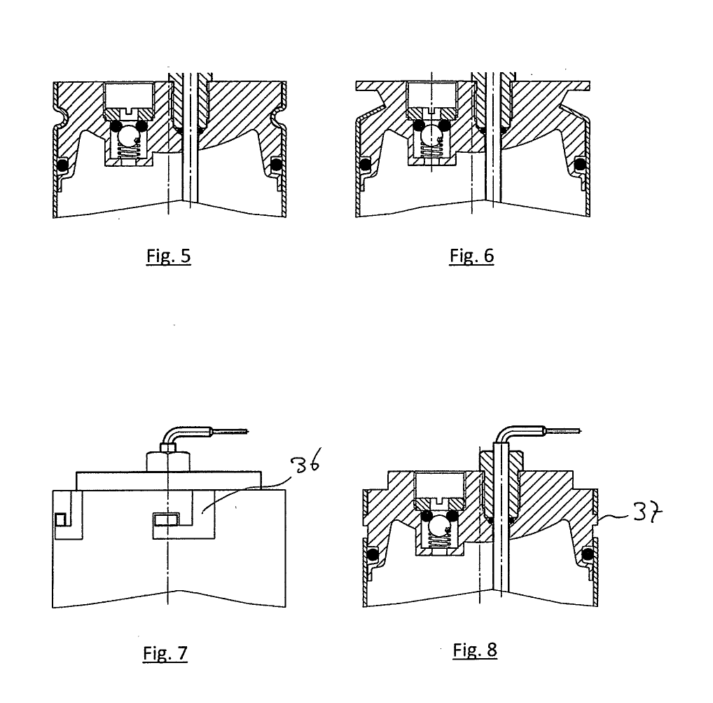

FIG. 5 is a partial cross-sectional view of a second preferred embodiment according to the present invention,

FIG. 6 is a partial cross-sectional view of a third preferred embodiment according to the present invention,

FIG. 7 is a partial view of a fourth preferred embodiment according to the present invention, and

FIG. 8 is a cross-sectional view of the embodiment in FIG. 7.

Referring now to FIG. 2, there are illustrated a container tube 1, the bottom end plate 2 which seals the tube 1 by the gasket 3; the top end plate 4, where there are formed the inlet and outlet passageways, the level check and the relief valve; the sealing of the tube 1 is assured by the gasket 18. There is then shown the CO₂ inlet 5; a nonreturn valve is inserted into the line and it is constituted by a ball 6 pushed by a spring 7 which seals against a gasket 8 held in seat by a ring nut 9. In a head 4 there is a seat for a feeler 10 covered by a sheath 11 and provided with a level sensor 14; the sealing is assured by a gasket 12 pushed to lock the feeler 10 by means of a ring nut 13 such that the level of the feeler 10 can also be adjustable.

FIG. 3 shows section corresponding to the water inlet 15, connected to an outer pump (not shown): besides a nonreturn valve like the one at CO₂ inlet there is the presence of a nozzle 16, suitably shaped and sealing by means of a gasket 17, sprinkling water in a chamber 19 with rebounding effect onto the underlying wall 20. It is further indicated the ground contact 21 of the envelope.

FIG. 4 shows the section corresponding to the soda outlet and the relief valve: there is indicated the outlet pipe fitting 22, which will be connected to the pouring tap and where comes the suction tube 23 sealing by means of a gasket 24 and held in seat by a ring nut 25. A relief valve 26 is constituted by a rod 27, with a gasket 28, pushed against the seat 29 by a spring 30 clashed by a ring nut 31; a ring 31 allows for manually leaking the carbonator trough a conduit 33. Even through said conduit 33 there will occur the vent as the pressure inside the carbonator will overcome the calibration value of said relief valve.

In such carbonator the end plates 2 and 4 are held by the tube 1 by means of a permanent set thereof achieved by a pair of rollings which facilitate noticeably the assembly process: in FIG. 1 there is indicate a channel 34 against which abuts said end plate 2 which is in turn blocked by a riveting 35 of the tube 1 achieved by rolling or forming. Without limiting in any way the invention the rolling along the channel 34 can be replaced by notches achieved by forming.

FIG. 5 shows a solution providing a single rolling or notches achieved by forming.

FIG. 6 shows a rolling solution which allows for achieving the end plate fastening in only one step.

FIGS. 7 and 8 show a possible solution providing a bayonet mounting wherein openings 36 are formed into the tube 1 and the corresponding mount teeth 37 onto the end plates along with different expedients for locking them once mounted.

1-6. (canceled)

7. A water carbonator comprising:
(i) a tubular body formed by metal material having two open ends,
(ii) a pair of closure elements formed by plastic material for said tubular body, wherein at least one of said closure elements comprises inlets for fluids to be mixed and at least one outlet for the mixed fluid, wherein
said closure elements are each fitted between and supported by a radially rolled portion of said tubular body and an inwardly bent portion of said tubular body, each closure element partially protruding from respective said open end.

8. The water carbonator according to claim 7, wherein said closure elements are provided with at least one outer groove housing sealing gaskets.
